(19) United States
(12) Patent Application Publication
(10) Pub. No.: US 2017/0272309 A1
(43) Pub. Date: Sep. 21, 2017

(54) INFORMATION PROCESSING APPARATUS, INFORMATION PROCESSING SYSTEM, NON-TRANSITORY COMPUTER-READABLE RECORDING MEDIUM, AND METHOD OF PROCESSING INFORMATION

(71) Applicant: FUJITSU LIMITED, Kawasaki-shi (JP)

(72) Inventors: Shigeru Ichihashi, Yokohama (JP); Shingo Suzuki, Kanagawa (JP); Ichiro Suzuki, Ohta (JP); Tetsuharu Sakurai, Yokohama (JP); Kohei Nakahara, Yokohama (JP)

(73) Assignee: FUJITSU LIMITED, Kawasaki-shi (JP)

(21) Appl. No.: 15/437,545

(22) Filed: Feb. 21, 2017

(30) Foreign Application Priority Data
Mar. 15, 2016 (JP) 2016-051395

(51) Int. Cl. H04L 12/24; H04L 29/08

(52) U.S. Cl. CPC H04L 41/0686; H04L 41/0645; H04L 41/0677; H04L 67/10

(57) ABSTRACT

An information processing apparatus includes a processor. The processor is configured to determine whether a communication is possible in a first segment, the first segment being defined between a communication unit that is provided in the first computing machine and communicates with the information processing apparatus, and a communication controller that is provided in the information processing apparatus and communicates with the service, determine whether a communication is possible in a second segment, the second segment being defined between the communication controller and one of a virtual machine provisioned in the first computing machine, an address of the service, and a second computing machine different from the first computing machine, and decide whether the service is available, a part of the service is available, or the service is unavailable, in accordance with a combination of a determination result for the first segment and a determination result for the second segment.

### CROSS-REFERENCE TO RELATED APPLICATIONS

This application is based upon and claims the benefit of priority of the prior Japanese Patent Application No. 2016-51395, filed on Mar. 15, 2016, the entire contents of which are incorporated herein by reference.

### FIELD

The embodiment discussed herein relates to an information processing apparatus, an information processing system, a non-transitory computer-readable recording medium having a program stored therein, and a method of processing information.

### BACKGROUND

In recent years, a lot of products are developed for providing applications or infrastructures as cloud services (such products may also be referred to as “service platform products”).

A service platform product is introduced into an administrating server, and collaborates with a cloud service. A subscriber accesses the service platform product and the cloud service using a client (e.g., “Web browser”).

The service platform product includes three components: an adaptor unit that collaborates with the service; a service catalog that displays contents obtained by the adaptor unit to the user; and a purchased service purchased by the subscriber.

When a failure occurs or a maintenance is carried out in the collaborated service or between the collaborated service and the adaptor unit, the adaptor unit communicating with the collaborated service transitions to an unavailable state. On the other hand, the service catalog and the purchased service have data that are independent of the service platform product, and do not synchronize the state of the adaptor unit.

As a result, the states of service catalog and the purchased service displayed to the subscriber remain the available states.

A technique is known which checks the state of a service, and when the service is unavailable, notifies a subscriber of the unavailability of the service (e.g., Patent Document 1).
Patent Document 1: Japanese Laid-open Patent Publication No. 2013-228803

Even when a failure occurs or a maintenance is carried out in the collaborated service or between the collaborated service and the adaptor unit, in some cases, however, a part of the service remains available. In such a case, when a subscriber is unconditionally notified that the service is unavailable, the subscriber would misunderstand that all of the service is unavailable even when only a part of the service is available.

### SUMMARY

In one aspect, an information processing apparatus connected to a first computing machine configured to provide a service, the information processing apparatus includes a processor configured to determine whether a communication is possible in a first segment, the first segment being defined between a communication unit that is provided in the first computing machine and communicates with the information processing apparatus, and a communication controller that is provided in the information processing apparatus and communicates with the service, determine whether a communication is possible in a second segment, the second segment being defined between the communication controller and one of a virtual machine provisioned in the first computing machine, an address of the service, and a second computing machine different from the first computing machine, and decide whether the service is available, a part of the service is available, or the service is unavailable, in accordance with a combination of a determination result for the first segment and a determination result for the second segment.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram schematically depicting a hardware configuration of an information processing system as one example of an embodiment;

FIG. 2 is a diagram illustrating an example of a service platform product in the information processing system as one example of an embodiment;

FIG. 3 is a diagram illustrating a state transition of a service platform product when connecting to an application providing cloud service, in a first example of a related art;

FIG. 4 is a diagram illustrating a state transition of a service platform product when connecting to an infrastructure providing cloud service, in the first example of a related art;

FIG. 5 is a diagram illustrating a state transition of a service platform product when connecting to a contract administrating cloud service, in the first example of a related art;

FIG. 6 is a flowchart illustrating state change processing in the service platform product, in the first example of a related art;

FIG. 7 is a diagram illustrating a state transition of a service platform product in a second example of a related art;

FIG. 8 is a flowchart illustrating state change processing in the service platform product, in the second example of a related art;

FIG. 9 is a diagram schematically depicting a hardware configuration of an administrating server as one example of an embodiment;

FIG. 10 is a diagram schematically depicting a specific example of a hardware configuration of the information processing system as one example of an embodiment;

FIG. 11 is a diagram depicting a service state administration table when connecting to an application providing cloud service, in the administrating server as one example of an embodiment;

FIG. 12 is a diagram depicting a service state administration table when connecting to an infrastructure providing cloud service, in the administrating server as one example of an embodiment;

FIG. 13 is a diagram depicting a service state administration table when connecting to a contract administrating cloud service, in the administrating server as one example of an embodiment;

FIG. 14 is a diagram illustrating an example of a state transition of the service platform product in the information processing system as one example of an embodiment;

FIG. 15 is a flowchart illustrating state change processing in the service platform product in the information processing system as one example of an embodiment;

FIG. 16 is a flowchart illustrating details of the state change processing of the service platform product when connecting to an application providing cloud service, in the administrating server as one example of an embodiment;

FIG. 17 is a flowchart illustrating details of the state change processing of the service platform product when connecting to an infrastructure providing cloud service, in the administrating server as one example of an embodiment; and

FIG. 18 is a flowchart illustrating details of the state change processing of the service platform product when connecting to a contract administrating cloud service, in the administrating server as one example of an embodiment.

### DESCRIPTION OF EMBODIMENT(S)

Hereinafter, one embodiment will be described with reference to the drawings. The embodiment described below, however, is merely exemplary, and it is not intended to exclude various modifications and application to the technique that are not explicitly discussed in the embodiments. In other words, the present embodiment may be practiced in a wide variety of modifications without departing from the spirit thereof.

In addition, it is not intended that only the elements depicted in the drawings are provided, and thus other functions, elements, and the like, may be included.

In the drawings, like reference symbols denote similar elements and thus descriptions therefor will be omitted.

(A) One Example of First Embodiment

(A-1) System Configuration

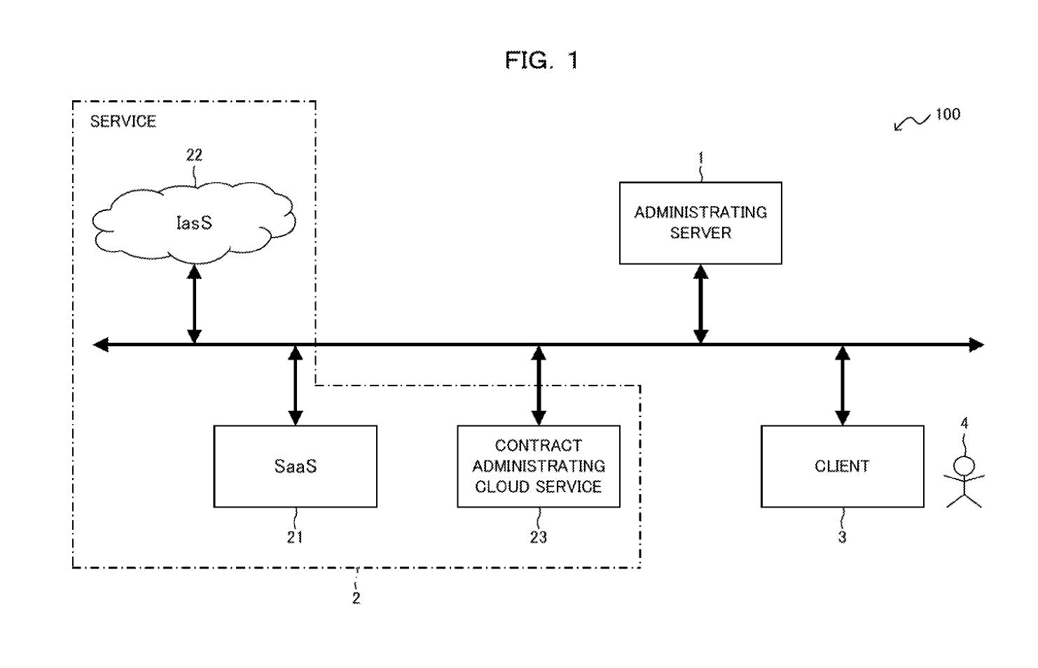

FIG. 1 is a diagram schematically depicting a hardware configuration of an information processing system 100 as one example of an embodiment.

The information processing system 100 includes an administrating server 1, a SaaS server 21, an IaaS server 22, a contract administrating cloud service server 23, and a client terminal 3. “SaaS” is an abbreviation for software as a service. “IaaS” is an abbreviation for an infrastructure as a service.

Hereinafter, the SaaS server 21, the IaaS server 22, the contract administrating cloud service server 23, and the client terminal 3 may be simply referred to as the SaaS 21, the IaaS 22, the contract administrating cloud service 23, and the client 3, respectively.

The administrating server 1, the SaaS 21, the IaaS 22, the contract administrating cloud service 23, and the client 3 are communicatively connected to each other. The SaaS 21, the IaaS 22, and the contract administrating cloud service 23 configure a service 2 provided to a subscriber (may also be referred to as “user”) 4.

The client 3 is a computer used by the subscriber 4 for accepting provision of the service 2. The client 3 accepts provision of the service 2, by connecting to the SaaS 21, the IaaS 22, or the contract administrating cloud service 23 via the administrating server 1.

The SaaS 21 is one example of a first computing machine, and may also be referred to as an application providing cloud service. The SaaS 21 provides the subscriber 4 with storage areas, for example.

The IaaS 22 is one example of the first computing machine, and may also be referred to as an infrastructure providing cloud service. The IaaS 22 provides the subscriber 4 with a virtual machine, for example.

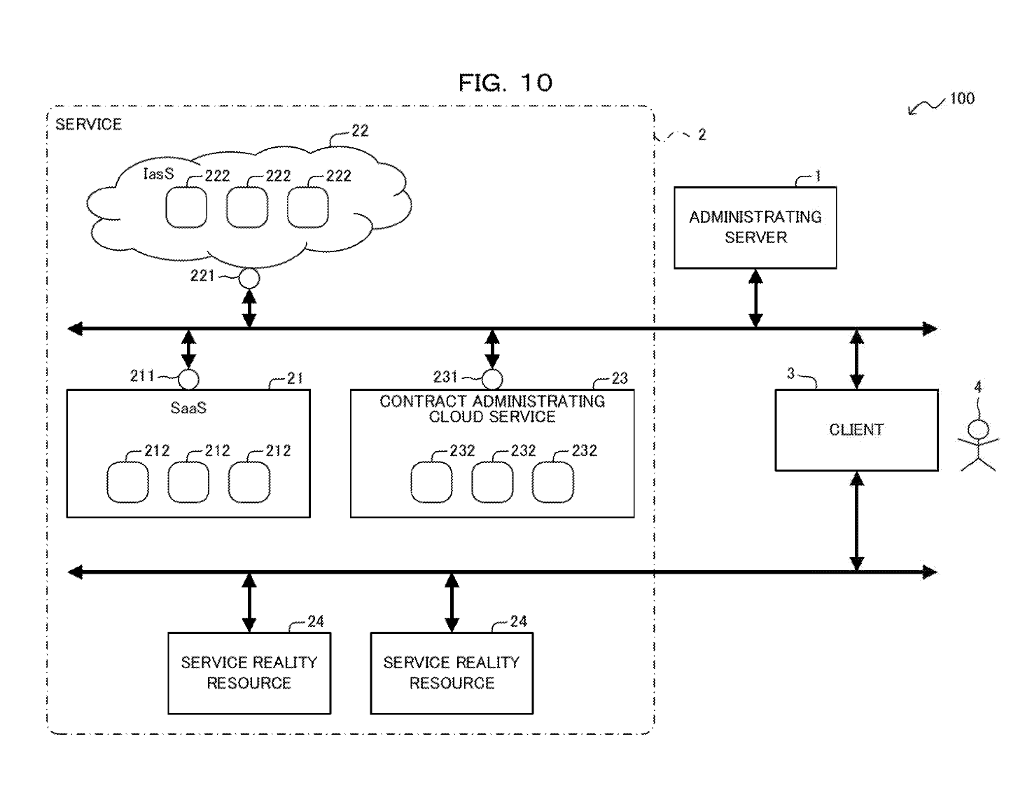

The contract administrating cloud service 23 is one example of a computing machine (i.e., “first computing machine”). The contract administrating cloud service 23 makes a contract with the subscriber 4, for the service 2 and the like. Once a contract for the service 2 is made by the contract administrating cloud service 23, an administrator of the information processing system 100 manually configures a service reality resource 24 (which will be described later with reference to FIG. 10) for the subscriber 4 who has made the contract for the service 2.

The administrating server 1 is one example of an information processing apparatus, and may also be referred to as an administrating server for a service platform product. The administrating server 1 administers the connection between the client 3 and the service 2, and whether or not the service 2 can be operated from the client 3.

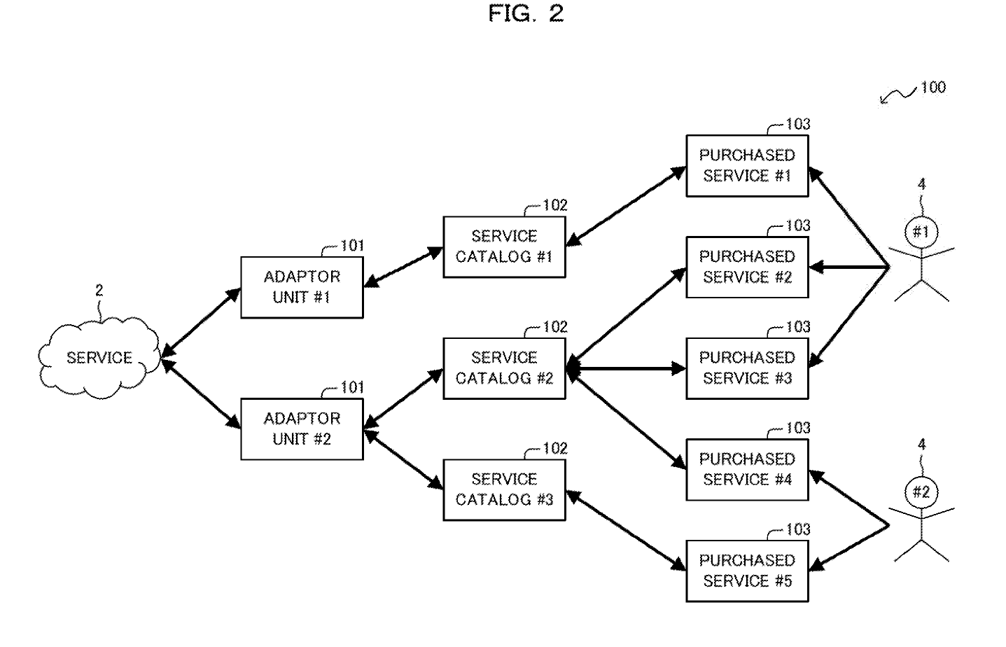

FIG. 2 is a diagram illustrating an example of a service platform product in the information processing system 100 as one example of an embodiment. In FIG. 2, the client 3 is not illustrated.

The service platform product is provisioned in the administrating server 1 and includes multiple (two in the depicted example) adaptor units 101, multiple (three in the depicted example) service catalogs 102, and multiple (five in the depicted example) purchased services 103. The service platform product relays between clients 3 used by subscribers 4 and the service 2. The adaptor units 101, the service catalogs 102, and the purchased services 103 may also be referred to as elements.

Referring to FIG. 2, the adaptor units 101 may be referred to as the “adaptor unit #1” or the “adaptor unit #2”. The service catalogs 102 may be referred to as the “the service catalog #1”, the “the service catalog #2”, or the “the service catalog #3”. The purchased services 103 may be referred to as the “purchased service #1”, the “purchased service #2”, the “purchased service #3”, the “purchased service #4”, or the “purchased service #5”. The subscribers 4 may be referred to as the “the subscriber #1” or the “the subscriber #2”.

The adaptor units 101 collaborate with the service 2. Specifically, the adaptor units 101 set the uniform resource locators (URL) for provisions and/or operations and the access URL of the service 2. The adaptor units 101 define various parameters.

As the URL for provisions and/or operations, “http://10.111.222.33/ProvisioningService” or “http://10.111.222.33/OperationServiece” is set, for example. As the access URL, “http://10.111.222.33/ExampleApp” is set, for example. To the parameters, “Template”, “Disk Size”, and “Period” are defined as parameter identifiers (IDs), and “template type” and “disk size”, and “period” are defined as parameter names, for example.

The service catalogs 102 are the catalog of the service 2 provided to the subscriber 4. The description, the charge, the setting as to whether to display the parameters of the service 2 are set to the service catalogs 102.

The description of the service 2 contains a summarized description and a detailed description of the service 2, information on the provider of the service 2 (e.g., contact), and an icon image, for example.

The purchased services 103 indicate the service 2 (i.e., “contracts”) purchased by the user. Each purchased services 103 contains a comment tag, contact information, and parameter values of the subscribers 4.

The comment tag of a subscriber 4 contains a comment tag of the subscriber #1 or the subscriber #2, for example. The contact information contains a mail address and a street address, and a display name of a subscriber 4, for example. The parameter value contains the disk size in the case of the SaaS 21; the template type (e.g., the high spec) in the case of the IaaS 22; or the period in the case of the contract administrating cloud service 2, for example.

The subscribers 4 access the service 2, using the purchased services 103, the service catalogs 102, and the adaptor units 101. In other words, the subscribers 4 access the service 2, via the purchased services 103, the service catalogs 102, and the adaptor units 101.

In the example depicted in FIG. 2, the subscriber #1 can access the service 2 via the purchased service 1#1, the service catalog #1, and the adaptor unit #1. The subscriber #1 can also access the service 2 via the purchased service #2, the service catalog #2, and the adaptor unit #2. The subscriber #1 can also access the service 2 via the purchased service 1#3, the service catalog #2, and the adaptor unit #2.

Further, in the example depicted in FIG. 2, the subscriber #2 can access the service 2 via the purchased service #4, the service catalog #2, and the adaptor unit #2. The subscriber #2 can also access the service 2 via the purchased service 1#5, the service catalog #3, and the adaptor unit #2.

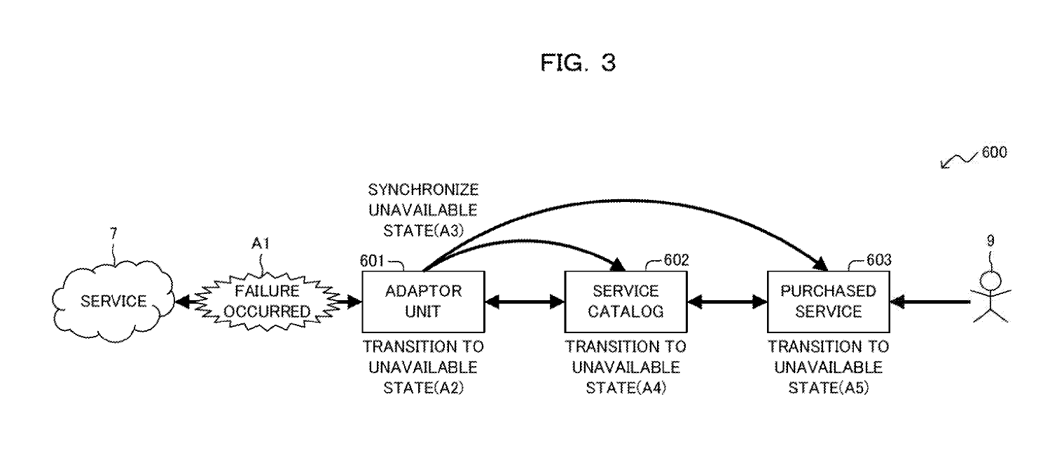

Before describing details of the information processing system 100 as one example of an embodiment, an information processing system 600 as a related art will be described with reference to FIGS. 3-8.

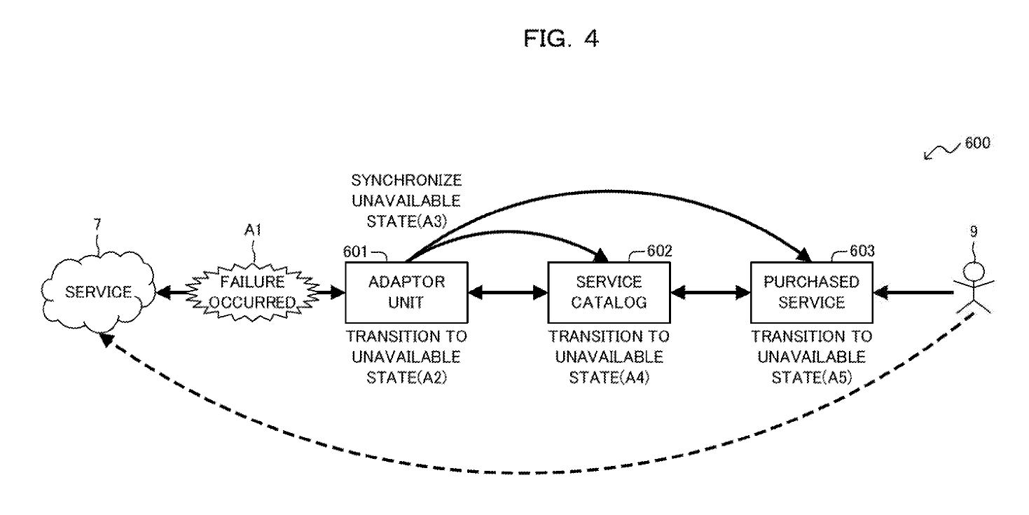

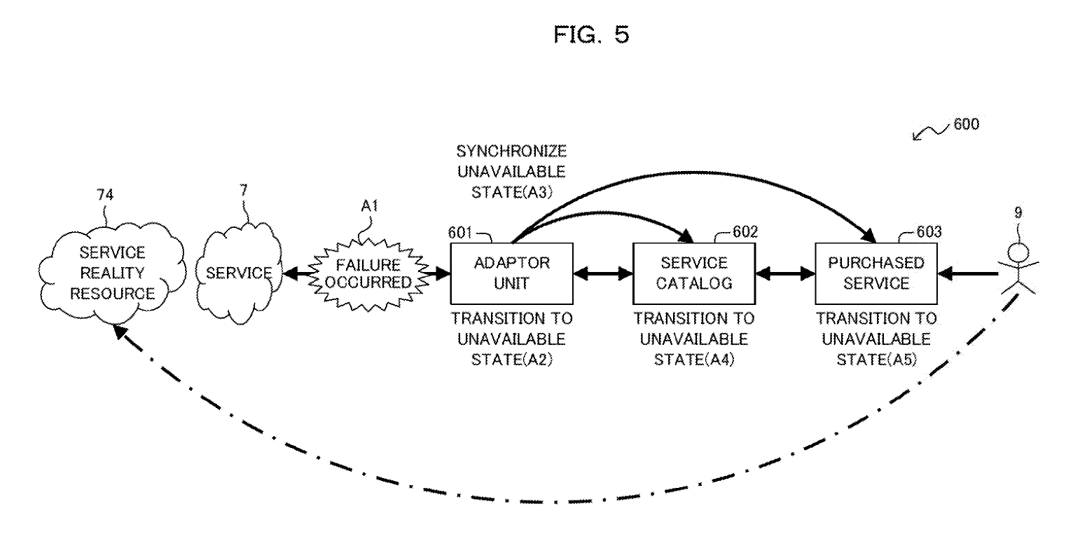

FIG. 3 is a diagram illustrating a state transition of a service platform product when connecting to an application providing cloud service (i.e., “SaaS”), in a first example of a related art. FIG. 4 is a diagram illustrating a state transition of a service platform product when connecting to an infrastructure providing cloud service (i.e., “IaaS”), in the first example of a related art. FIG. 5 is a diagram illustrating a state transition of a service platform product when connecting to a contract administrating cloud service, in the first example of a related art.

As depicted in FIGS. 3-5, the information processing system 600 as a related art includes an adaptor unit 601, a service catalog 602, a purchased service 603, and a service 7. The adaptor unit 601, the service catalog 602, and the purchased service 603 function as a service platform product, and the service platform product is provisioned in an administrating server (not illustrated in FIGS. 3-5).

The information processing system 600 depicted in FIG. 5 includes a service reality resource 74 that is provided after the subscriber 9 contracts for the service 7, in addition to the service platform product and the service 7.

The subscriber 9 accesses the service 7 via the purchased service 603, the service catalog 602, and the adaptor unit 601.

Referring to FIGS. 3-5, the state transition of a service platform product when a failure occurs between the adaptor unit 601 and the service 7 will be described.

When a failure occurs between the adaptor unit 601 and the service 7 (refer to the reference symbol A1), the adaptor unit 601 transitions to an unavailable state (refer to the reference symbol A2).

The adaptor unit 601 synchronizes the unavailable state with those in the service catalog 602 and the purchased service 603 (refer to the reference symbol A3).

The service catalog 602 and the purchased service 603 transition to an unavailable state (refer to the reference symbols A4 and A5).

In FIG. 3, since different port numbers are used for a usage and an operation of the service 7 when the subscriber 9 accesses the SaaS, the service 7 may close either the port used for a usage of the service 7 or the port used for an operation of the service 7 to disconnect the communication. Thus, in FIG. 3, although either a usage or an operation of the service 7 is possible, the unavailable state is set unconditionally.

In FIG. 4, when the subscriber 9 accesses the IasS, the subscriber 9 can directly access the service 7, bypassing the service platform product, as indicated by the broken line arrow in FIG. 4. In other words, in FIG. 4, although the service 7 is actually available, the subscriber 9 presumes that the service 7 is in an unavailable state.

In FIG. 5, the service reality resource 74 is provisioned after the contract with the contract administrating cloud service, and the service reality resource 74 and the adaptor unit 601 do not collaborate with each other. Hence, in FIG. 5, although the service reality resource 74 is actually available, the subscriber 9 presumes that the service 7 is in an unavailable state, as indicated by the dash-dot line arrow in FIG. 5.

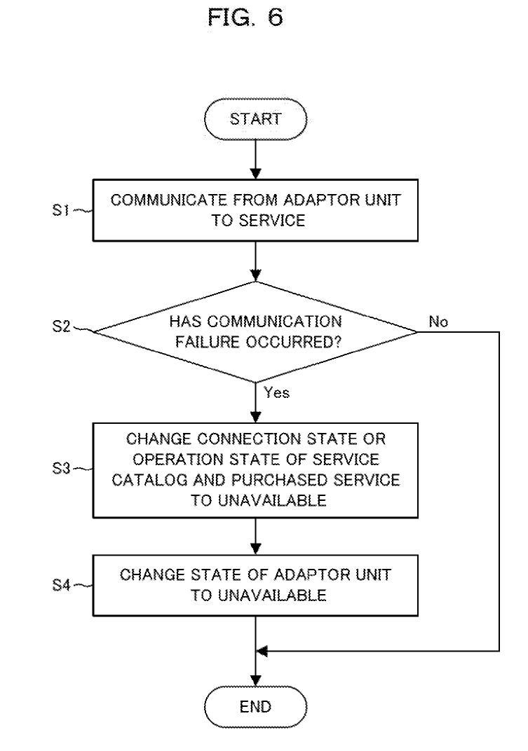

FIG. 6 is a flowchart illustrating state change processing in the service platform product, in the first example of a related art.

The administrating server carries out a communication from the adaptor unit 601 to the service 7 (Step S1).

The administrating server determines whether a communication failure has occurred (Step S2).

When no communication failure has been occurred (refer to the “No” route from Step S2), the processing ends.

Otherwise, when a communication failure has occurred (refer to the “Yes” route from Step S2), the administrating server changes the connection states or the operation states of the service catalog 602 and the purchased service 603 associated with the adaptor unit 601 to unavailable (Step S3).

The administrating server changes the state of the adaptor unit 601 to the unavailable state (Step S4), and the processing ends.

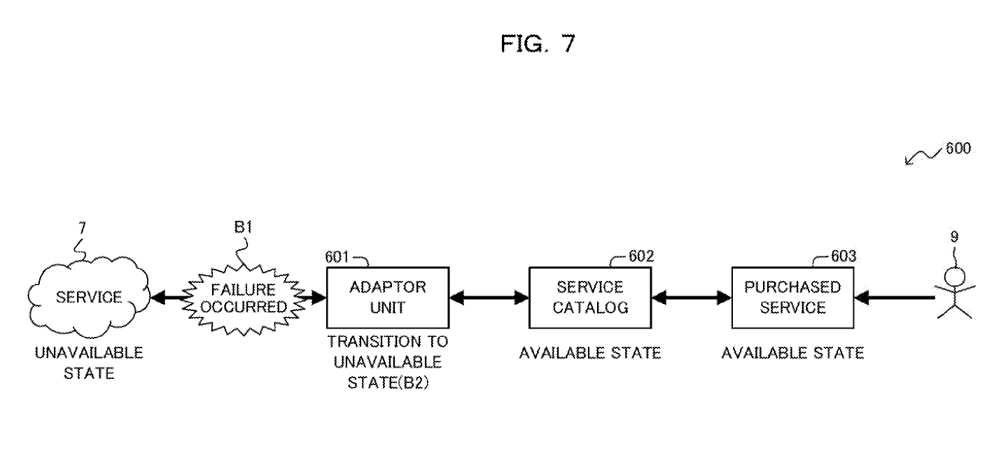

FIG. 7 is a diagram illustrating a state transition of a service platform product, in a second example of a related art.

As depicted in FIG. 7, similar to the information processing system 600 depicted in FIGS. 3-5, an information processing system 600 as a related art includes an adaptor unit 601, a service catalog 602, a purchased service 603, and a service 7.

Referring to FIG. 7, the state transition of a service platform product when a failure occurs between the adaptor unit 601 and the service 7 will be described.

When a failure occurs between the adaptor unit 601 and the service 7 (refer to the reference symbol B1), the adaptor unit 601 transitions to an unavailable state (refer to the reference symbol B2).

In the meantime, in the example depicted in FIG. 7, the service catalog 602 and the purchased service 603 remain in available states.

In FIG. 7, when the subscriber 9 attempts to use the service 7 via the purchased service 603, the service 7 is unavailable. As depicted in FIG. 7, however, when the state of the adaptor unit 601 is not synchronized with those of the service catalog 602 and the purchased service 603, the subscriber 9 presumes that the service 7 is available. When the subscriber 9 attempts to purchase a service 7 from the service catalog 602, or attempts to operate or connect to the service 7, the subscriber 9 finally realizes that the service 7 is unavailable.

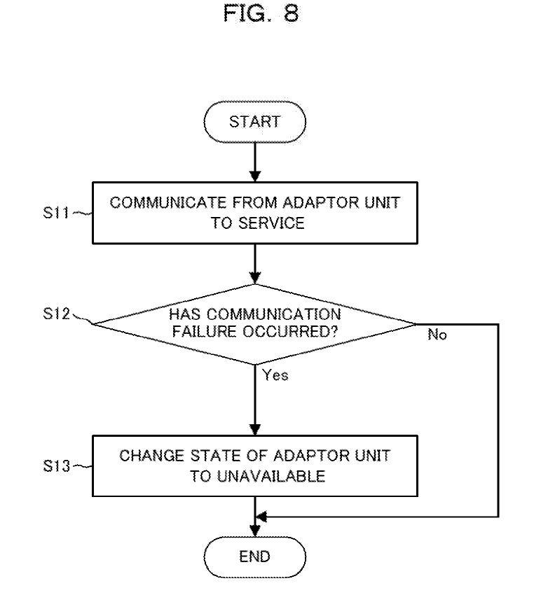

FIG. 8 is a flowchart illustrating state change processing in the service platform product, in the second example of a related art.

The administrating server carries out a communication from the adaptor unit 601 to the service 7 (Step S11).

The administrating server determines whether a communication failure has occurred (Step S12).

When no communication failure has been occurred (refer to the “No” route from Step S12), the processing ends.

Otherwise, when a communication failure has occurred (refer to the “Yes” route from Step S12), the administrating server changes the state of the adaptor unit 601 to the unavailable state (Step S13) and the processing ends.

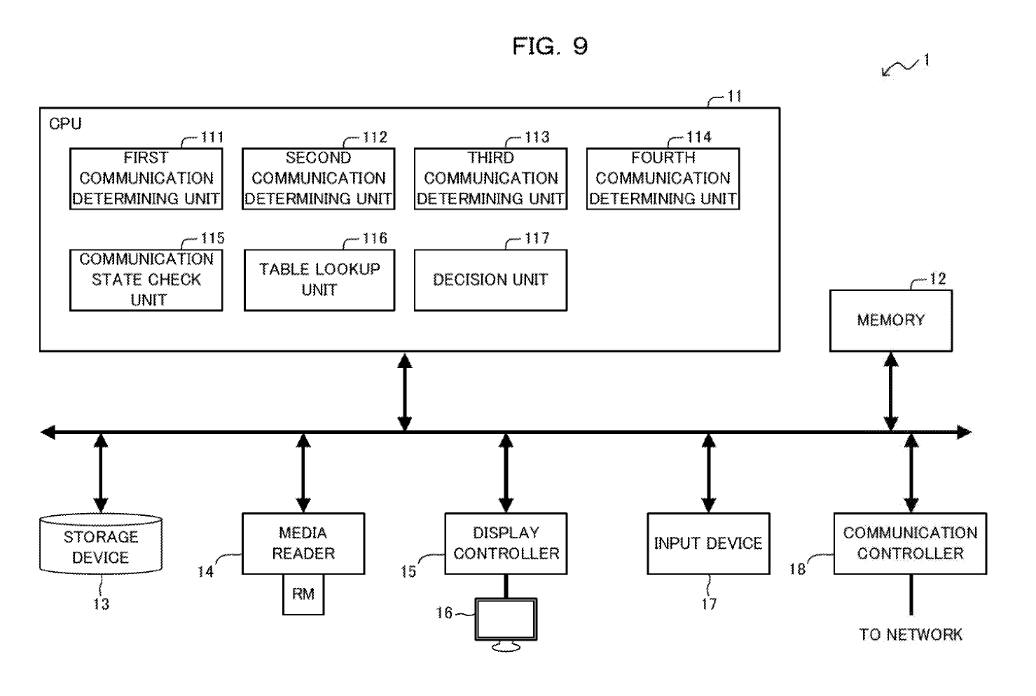

The administrating server 1 as one example of an embodiment includes a hardware configuration depicted in FIG. 9 for precisely determining whether all or apart of a connected service 2 is available.

FIG. 9 is a diagram schematically depicting a hardware configuration of the administrating server 1 as one example of an embodiment.

As depicted in FIG. 9, the administrating server 1 includes a central processing unit (CPU) 11, a memory 12, a storage device 13, a media reader 14, a display controller 15, a display device 16, an input device 17, and a communication controller 18.

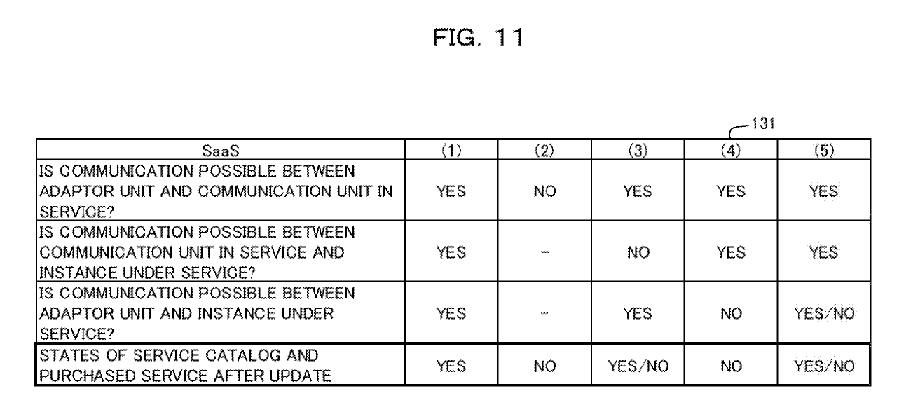

The storage device 13 is a device configured to store data in a readable and writable manner, and a hard disk drive (HDD), a solid state drive (SSD), or a storage class memory (SCM) may be used, for example. The storage device 13 stores information on a state administration table 131 that will be described later with reference to FIGS. 11-13.

The media reader 14 is configured such that a recording medium RM can be loaded into the media reader 14. When the recording medium RM is loaded, the media reader 14 is configured to be able to read information recorded in the recording medium RM. In this example, the recording medium RM is portable. The recording medium RM is a non-transitory computer-readable recording medium, and is a flexible disks, a CD (e.g., CD-ROM, CD-R, CD-RW), a DVD (e.g., DVD-ROM, DVD-RAM, DVD-R, DVD+R, DVD-RW, DVD+RW, HD DVD), a Blu-ray disk, a magnetic disk, an optical disk, a magneto-optical disk, a semiconductor memory, or the like, for example.

The display controller 15 controls to display various types of information on the display device 16, for an administrator of the administrating server 1 and other users.

The display device 16 is a liquid-crystal display, a cathode ray tube (CRT), an electronic paper display, or the like, and displays various types of information to the administrator of the administrating server 1 and other users.

The input device 17 is a mouse, a track ball, or a keyboard, for example. The administrator of the administrating server 1 makes a wide variety of input operations using the input device 17.

The display device 16 and the input device 17 may be integrated, and may be a touch panel, for example.

The communication controller 18 is an interface that communicatively connects the administrating server 1 to the service 2 and a client 3 (i.e., “network”). The communication controller 18 may also be referred to as a communication adapter (CA), and corresponds to the adaptor unit 101 of the service platform product.

The memory 12 is a memory device including a read only memory (ROM) and a random access memory (RAM). The ROM in the memory 12 has a program, such as a Basic Input/output System (BIOS) written therein. The software program in the memory 12 may be read into and executed by the CPU 11, where appropriate. The RAM in the memory may be used as a primary recording memory or a working memory.

The CPU 11 is a processor that carries out various controls and computations, and embodies various functions by executing an operating system (OS) and programs stored in the memory 12. Hence, as depicted in FIG. 9, the CPU 11 functions as a first communication determining unit 111, a second communication determining unit 112, a third communication determining unit 113, a fourth communication determining unit 114, a communication state check unit 115, a table lookup unit 116, and a decision unit 117.

Note that a program for embodying functions as the first communication determining unit 111, the second communication determining unit 112, the third communication determining unit 113, the fourth communication determining unit 114, the communication state check unit 115, the table lookup unit 116, and the decision unit 117 is provided in the form of a program recorded in the recording medium RM described above, for example. The computer then reads the program from the recording medium RM via the media reader 14, transfers it to an internal storage device or an external storage device, and stores therein, for using that program. Alternatively, the program may be recorded in a storage device (recording medium), such as a magnetic disk, an optical disk, a magneto-optical disk, or the like, for example, and may be provided from the storage device to the computer via a communication path.

Upon embodying functions as the first communication determining unit 111, the second communication determining unit 112, the third communication determining unit 113, the fourth communication determining unit 114, the communication state check unit 115, the table lookup unit 116, and the decision unit 117, a program stored in an internal storage device (the memory 12 in the present embodiment) is executed by a microprocessor in the computer (the CPU 11 in the present embodiment). Alternatively, the computer may read the program recorded in the recording medium RM and execute it.

The CPU 11 controls operations of the entire administrating server 1. The device for controlling operations of the entire administrating server 1 is not limited to the CPU 11, and may be any one of a micro processing unit (MPU), a digital signal processor (CSP), an application specific integrated circuit (ASIC), a programmable logic device (PLD), and a field programmable gate array (FPGA). Alternatively, the device for controlling operations of the entire administrating server 1 may be a combination of two or more of a CPU, an MPU, a DSP, an ASIC, a PLD, and an FPGA.

FIG. 10 is a diagram schematically depicting a specific example of a hardware configuration of the information processing system 100 as one example of an embodiment.

Before describing the functions as the first communication determining unit 111, the second communication determining unit 112, the third communication determining unit 113, the fourth communication determining unit 114, the communication state check unit 115, the table lookup unit 116, and the decision unit 117 depicted in FIG. 9, a description will be made with reference to FIG. 10.

In the example depicted in FIG. 10, the service 2 includes a SaaS 21, an IaaS 22, a contract administrating cloud service 23, and one or more (two in the depicted example) service reality resources 24.

The SaaS 21 includes a communication unit 211 and one or more (three in the depicted example) instances 212.

The communication unit 211 communicates with the administrating server 1 via a network.

Each instance 212 is an URL for accessing a server on which the service 2 operates (i.e., “the SaaS 21”), data provisioned in the cloud environment, or the service 2, for example. For example, the service 2 in the cloud supports multitenancy, and each instance 212 is identified by outputting a character string unique to each of purchased services 103 or subscribers 4 for the URL of the main body of the service 2.

When the SaaS 21 is an online storage service, the instances 212 are the URL of the online storage service, for example. When the SaaS 21 is an application, the instances 212 are the URL of a purchased service 103, for example.

The IaaS 22 includes a communication unit 221 and one or more (three in the depicted example) instances 222.

The communication unit 221 communicates with the administrating server 1 via the network.

The instances 222 are virtual machines, for example. In the case of the IaaS 22, since the service 2 is a virtualization software, a virtual machine created in the virtualization software corresponds to an instance.

The contract administrating cloud service 23 includes a communication unit 231 and one or more (three in the depicted example) instances 232.

The communication unit 231 communicates with the administrating server 1 via the network.

Each instance 232 is data created for each purchased service 103. The instances 232 contain parameter values specified by the subscriber 4 upon a contract of the service 2.

The service reality resources 24 are one example of a computing machine (i.e., “second computing machine”). The service reality resources 24 are provided in order to provide the subscriber 4 with the service 2 after making a contract with the subscriber 4.

Specifically, a service reality resource 24 is created by the administrator of the contract administrating cloud service 23, by looking up parameter values stored in the instances 232. Information on the created service reality resource 24 is notified to the subscriber 4 by the administrator.

When the contract administrating cloud service 23 is a “reservation service of a physical machine”, a service reality resource 24 is constructed by looking up the usage start date, machine specification, and the place where the machine is placed, for example, specified for the purchased service 103.

Next, the functions as the first communication determining unit 111, the second communication determining unit 112, the third communication determining unit 113, the fourth communication determining unit 114, the communication state check unit 115, the table lookup unit 116, and the decision unit 117 depicted in FIG. 9 will be described.

The communication state check unit 115 checks whether a failure occurs in a communication from the adaptor unit 101 to the service 2. When a failure occurs in a communication, the communication state check unit 115 checks the communication state in a certain segment between the administrating server 1 and the service 2.

Specifically, the communication state check unit 115 checks the communication state between the adaptor unit 101 in the administrating server 1 and the communication unit 211, 221, or 231 in the service 2, in a connection with the SaaS 21, the IaaS 22, or the contract administrating cloud service 23. Further, the communication state check unit 115 checks the communication state between the communication unit 211 or 221 in the service 2 and the instance 212 or 222 under the service 2, in the connection with the SaaS 21 or the IaaS 22. Further, the communication state check unit 115 checks the communication state between the adaptor unit 101 in the administrating server 1 and the instance 212 or 222 under the service 2, in the connection with the SaaS 21 or the IaaS 22. Further, the communication state check unit 115 checks the communication state between the adaptor unit 101 in the administrating server 1 and the service reality resource 24, in the connection with the contract administrating cloud service 23.

The table lookup unit 116 looks up the state administration table 131 that will be described later with reference to FIGS. 11-13.

Specifically, the table lookup unit 116 determines whether the type of the purchased service 103 (i.e., “connection type”) is either the SaaS 21, the IaaS 22, or the contract administrating cloud service 23. The table lookup unit 116 may obtain the connection type in advance, at the time when the adaptor unit 101 is registered. The table lookup unit 116 then reads the state administration table 131 related to the determined type of the purchased service 103 from the storage device 13, and looks up the state administration table 131 that has been read.

The first communication determining unit 111 is one example of a first determining unit. The first communication determining unit 111 determines whether a communication is possible between the adaptor unit 101 and the communication unit 211, 221, or 231 in the service 2, in the communication with the SaaS 21, the IaaS 22, or the contract administrating cloud service 23.

The second communication determining unit 112 is one example of a third determining unit. The second communication determining unit 112 determines whether a communication is possible between the communication unit 211 or 221 in the service 2 and the instance 212 or 222 under the service 2, in the communication with the SaaS 21 or the IaaS 22.

The third communication determining unit 113 is one example of a second determining unit. The third communication determining unit 113 determines whether a communication is possible between the adaptor unit 101 and the instances 212 or 222 under the service 2, in the communication with the SaaS 21 or the IaaS 22.

The fourth communication determining unit 114 is one example of the second determining unit. The fourth communication determining unit 114 determines whether a communication is possible between the adaptor unit 101 and the service reality resource 24, in the communication with the contract administrating cloud service 23.

Thus, the first determining unit corresponding to the first communication determining unit 111 is configured to determine whether a communication is possible in a first segment between the administrating server 1 and the service 2.

Further, the second determining unit corresponding to the third communication determining unit 113 or the fourth communication determining unit 114 is configured to determine whether a communication is possible in a second segment that is different from the first segment.

By determining whether communications are possible in the first and second segments, a decision unit 117, which will be described later, can finely decide the availability of the service 2.

Furthermore, the third determining unit corresponding to the second communication determining unit 112 is configured to determine whether a communication is possible in a third segment, which is different from the first segment or the second segment.

By determining whether communications are possible in the third segment, in addition to the first and second segments, it is possible to improve the reliability of decisions by the decision unit 117, which will be described later, on the availability of the service 2.

The decision unit 117 changes the connection state to the service 2 or the operation state of the service 2 in the service catalog 102 and the purchased service 103.

Specifically, the decision unit 117 searches the state administration table 131, for a combination corresponding to at least two of determination results by the first communication determining unit 111, the second communication determining unit 112, the third communication determining unit 113, and the fourth communication determining unit 114. The decision unit 117 then changes the connection state to the service 2 or the operation state of the service 2. The decision unit 117 decides whether the service 2 is in an available state, apart of the service 2 is in an available state, or the service 2 is in an unavailable state, as the connection state to the service 2 or the operation state of the service 2.

As a result, it is possible to precisely determine whether all or a part of the connected service 2 is available.

When an unavailable state of the adaptor unit 101 is not synchronized with those of the service catalog 102 and the purchased service 103, the subscriber 4 presumes that the service 2 is available even though the service 2 is actually unavailable via the purchased service 103. When the subscriber 4 attempts to purchase a service 2 from the service catalog 102, or attempts to operate or connect to the service 2, the subscriber 4 finally realizes that the service 2 is unavailable. In contrast, in accordance with the information processing system 100 as one example of an embodiment, it is possible to match an actual available state (or unavailable state) of the service 2 with an available state (or unavailable state) of the service 2 recognized by the subscriber 4.

When the unavailable state of the adaptor unit 101 is unconditionally synchronized with those of the service catalog 102 and the purchased service 103, a discrepancy arises in the service charge of the purchased service 103 that allows the subscriber 4 to directly access a collaborated service 2 after a purchase of the service 2. Specifically, when a communication is generated with the adaptor unit 101, the subscriber 4 can directly use the service 2 collaborating with the collaborated service 2. When the purchased service 103 transitions to an unavailable state, the charged fee of the service charge is reduced. As a result, a discrepancy arises between the charge calculation by the cloud service platform and the service charge of the real service. In contrast, in the information processing system 100 as one example of an embodiment, it is possible to match the charge calculation by the cloud service platform with the service charge of the actual service.

When all or a part of the service 2 is unavailable, the decision unit 117 may control the display controller 15 to stop displaying relevant buttons that are usually displayed on the display device 16.

Next, details of the connection state to the service 2 or the operation state of the service 2 will be described with reference to FIGS. 11-13.

FIG. 11 is a diagram depicting the state administration table 131 when connecting to the application providing cloud service (i.e., “SaaS”) 21, in the administrating server 1 as one example of an embodiment.

In the tables depicted in FIGS. 11-13, the “YES” indicates the state where a communication (i.e., “a connection and an operation”) is possible, while “NO” indicates the state where a communication (i.e., “a connection and an operation”) is not possible. Further, “YES/NO” indicates the state where a connection is possible but an operation is not possible, whereas “NO/YES” indicates the state where a communication is not possible but an operation is possible. Further, “-” indicates that whether a communication is possible or not is irrelevant, whereas “MANUAL” indicates that a predefined state is set by an administrator.

As depicted in FIG. 11, the following States (1) to (5) are defined as the states of the service catalog 102 and the purchased service 103 after an update in a communication with the SaaS 21:

State (1) is the situation where a communication is possible between the adaptor unit 101 and the communication unit 211 in the service 2, a communication is possible between the communication unit 211 in the service 2 and the instances 212 under the service 2, and a communication is possible between the adaptor unit 101 and the instances 212 under the service 2. In such a situation, the decision unit 117 sets the state to the state where a connection and an operation are possible, in the service catalog 102 and the purchased service 103.

As a result, the subscriber 4 can recognize that a connection to the service 2 and an operation of the service 2 are possible.

State (2) is the situation where a communication is not possible between the adaptor unit 101 and the communication unit 211 in the service 2. In such a situation, the decision unit 117 sets the state to the state where neither a connection nor an operation is possible, in the service catalog 102 and the purchased service 103.

As a result, the subscriber 4 can recognize that neither a connection to the service 2 nor an operation of the service 2 is possible.

State (3) is the situation where a communication is possible between the adaptor unit 101 and the communication unit 211 in the service 2, a communication is not possible between the communication unit 211 in the service 2 and the instances 212 under the service 2, and a communication is possible between the adaptor unit 101 and the instances 212 under the service 2. In such a situation, the decision unit 117 sets the state to the state where a connection is possible but an operation is not possible, in the service catalog 102 and the purchased service 103.

As a result, the subscriber 4 can identify which part of the service 2 is available.

State (4) is the situation where a communication is possible between the adaptor unit 101 and the communication unit 211 in the service 2, a communication is possible between the communication unit 211 in the service 2 and the instances 212 under the service 2, and a communication is not possible between the adaptor unit 101 and the instances 212 under the service 2. In such a situation, the decision unit 117 sets the state to the state where neither a connection nor an operation is possible, in the service catalog 102 and the purchased service 103.

As a result, the subscriber 4 can recognize that neither a connection to the service 2 nor an operation of the service 2 is possible.

State (5) is the situation where a communication is possible between the adaptor unit 101 and the communication unit 211 in the service 2, a communication is possible between the communication unit 211 in the service 2 and the instances 212 under the service 2, and a connection is possible but an operation is not possible between the adaptor unit 101 and the instances 212 under the service 2. In such a situation, the decision unit 117 sets the state to the state where a connection is possible but an operation is not possible, in the service catalog 102 and the purchased service 103.

As a result, the subscriber 4 can identify which part of the service 2 is available.

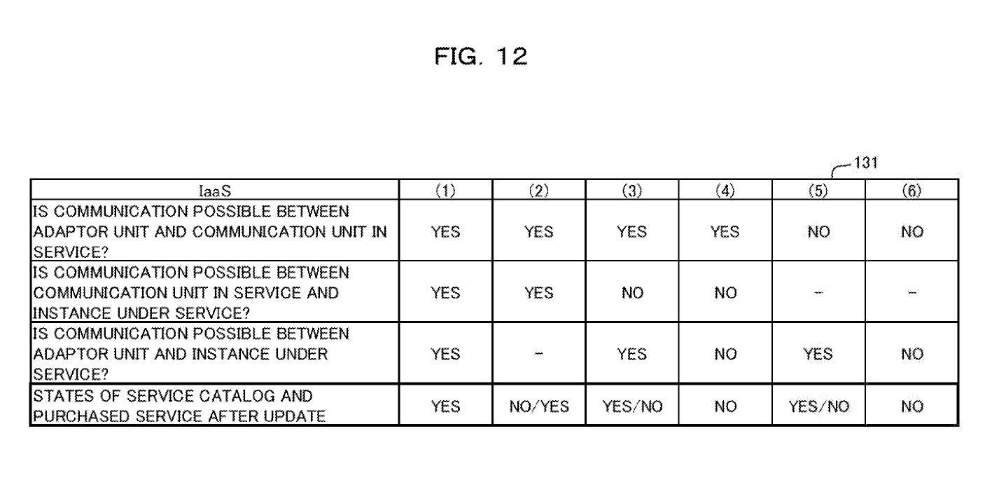

FIG. 12 is a diagram depicting the state administration table 13 when connecting to the infrastructure providing cloud service (i.e., “IaaS”) 22, in the administrating server 1 as one example of an embodiment.

As depicted in FIG. 12, the following States (1) to (6) are defined as the states of the service catalog 102 and the purchased service 103 after an update in a communication with the IaaS 22:

State (1) is the situation where a communication is possible between the adaptor unit 101 and the communication unit 211 in the service 2, a communication is possible between the communication unit 221 in the service 2 and the instances 212 under the service 2, and a communication is possible between the adaptor unit 101 and the instances 212 under the service 2. In such a situation, the decision unit 117 sets the state to the state where a connection and an operation are possible, in the service catalog 102 and the purchased service 103.

As a result, the subscriber 4 can recognize that a connection to the service 2 and an operation of the service 2 are possible.

State (2) is the situation where a communication is possible between the adaptor unit 101 and the communication unit 211 in the service 2, and a communication is possible between the communication unit 221 in the service 2 and the instances 212 under the service 2. In such a situation, the decision unit 117 sets the state to the state where a connection is not possible but an operation is possible, in the service catalog 102 and the purchased service 103.

As a result, the subscriber 4 can identify which part of the service 2 is available.

State (3) is the situation where a communication is possible between the adaptor unit 101 and the communication unit 211 in the service 2, a communication is not possible between the communication unit 221 in the service 2 and the instances 212 under the service 2, and a communication is possible between the adaptor unit 101 and the instances 212 under the service 2. In such a situation, the decision unit 117 sets the state to the state where a connection is possible but an operation is not possible, in the service catalog 102 and the purchased service 103.

As a result, the subscriber 4 can identify which part of the service 2 is available.

State (4) is the situation where a communication is possible between the adaptor unit 101 and the communication unit 211 in the service 2, a communication is not possible between the communication unit 221 in the service 2 and the instances 212 under the service 2, and a communication is not possible between the adaptor unit 101 and the instances 212 under the service 2. In such a situation, the decision unit 117 sets the state to the state where neither a connection nor an operation is possible, in the service catalog 102 and the purchased service 103.

As a result, the subscriber 4 can recognize that neither a connection to the service 2 nor an operation of the service 2 is possible.

State (5) is the situation where a communication is not possible between the adaptor unit 101 and the communication unit 211 in the service 2, and a communication is possible between the adaptor unit 101 and the instances 212 under the service 2. In such a situation, the decision unit 117 sets the state to the state where a connection is possible but an operation is not possible, in the service catalog 102 and the purchased service 103.

As a result, the subscriber 4 can identify which part of the service 2 is available.

State (6) is the situation where a communication is not possible between the adaptor unit 101 and the communication unit 211 in the service 2, and a communication is not possible between the adaptor unit 101 and the instances 212 under the service 2. In such a situation, the decision unit 117 sets the state to the state where neither a connection nor an operation is possible, in the service catalog 102 and the purchased service 103.

As a result, the subscriber 4 can recognize that neither a connection to the service 2 nor an operation of the service 2 is possible.

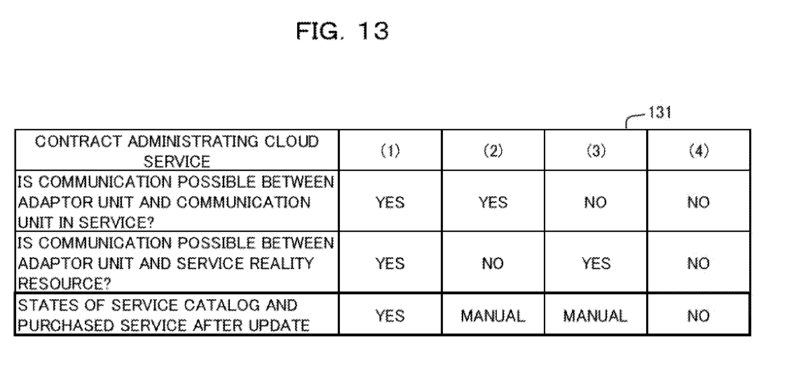

FIG. 13 is a diagram depicting the state administration table 13 when connecting to the contract administrating cloud service 23, in the administrating server 1 as one example of an embodiment.

As depicted in FIG. 13, the following States (1) to (4) are defined as the states of the service catalog 102 and the purchased service 103 after an update in a communication with the contract administrating cloud service 23.

State (1) is the situation where a communication is possible between the adaptor unit 101 and the communication unit 211 in the service 2, and a communication is possible between the adaptor unit 101 and the service reality resource 24. In such a situation, the decision unit 117 sets the state to the state where a connection and an operation are possible, in the service catalog 102 and the purchased service 103.

As a result, the subscriber 4 can recognize that a connection to the service 2 and an operation of the service 2 are possible.

State (2) is the situation where a communication is possible between the adaptor unit 101 and the communication unit 211 in the service 2, and a communication is not possible between the adaptor unit 101 and the service reality resource 24. In such a situation, the decision unit 117 sets the states of the service catalog 102 and the purchased service 103 to a state defined by an administrator in advance.

As a result, the subscriber 4 can recognize that the state of the service 2 has transitioned to the states defined by the administrator in advance.

State (3) is the situation where a communication is not possible between the adaptor unit 101 and the communication unit 211 in the service 2, and a communication is possible between the adaptor unit 101 and the service reality resource 24. In such a situation, the decision unit 117 sets the states of the service catalog 102 and the purchased service 103 to a state defined by an administrator in advance.

As a result, the subscriber 4 can recognize that the state of the service 2 has transitioned to the states defined by the administrator in advance.

State (4) is the situation where a communication is not possible between the adaptor unit 101 and the communication unit 211 in the service 2, and a communication is not possible between the adaptor unit 101 and the service reality resource 24. In such a situation, the decision unit 117 sets the state to the state where neither a connection nor an operation is possible, in the service catalog 102 and the purchased service 103.

As a result, the subscriber 4 can recognize that neither a connection to the service 2 nor an operation of the service 2 is possible.

(A-2) Operations

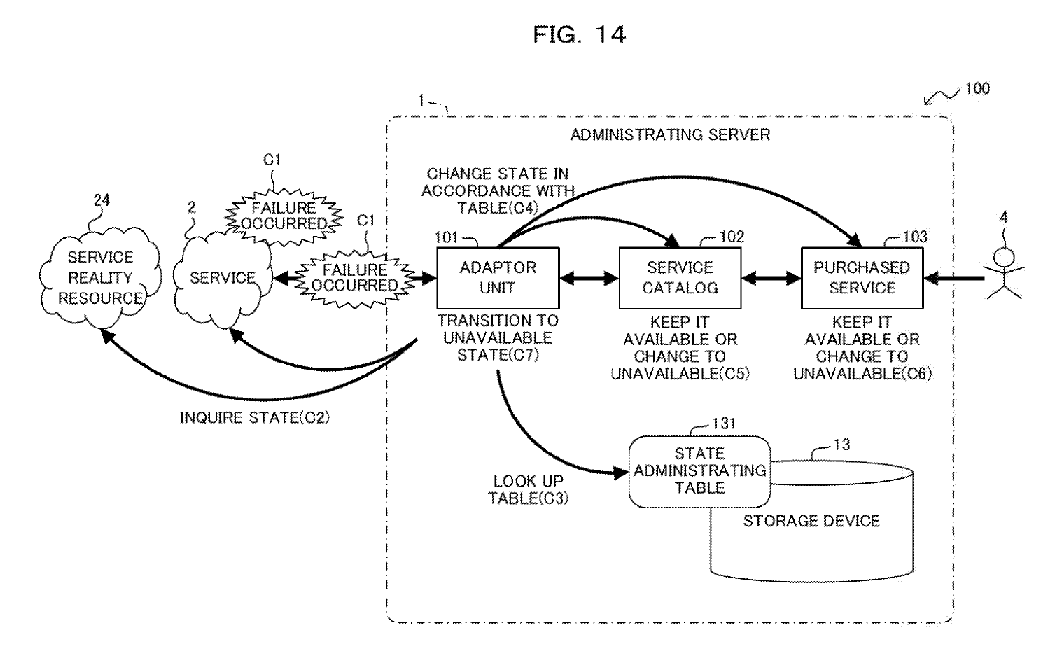

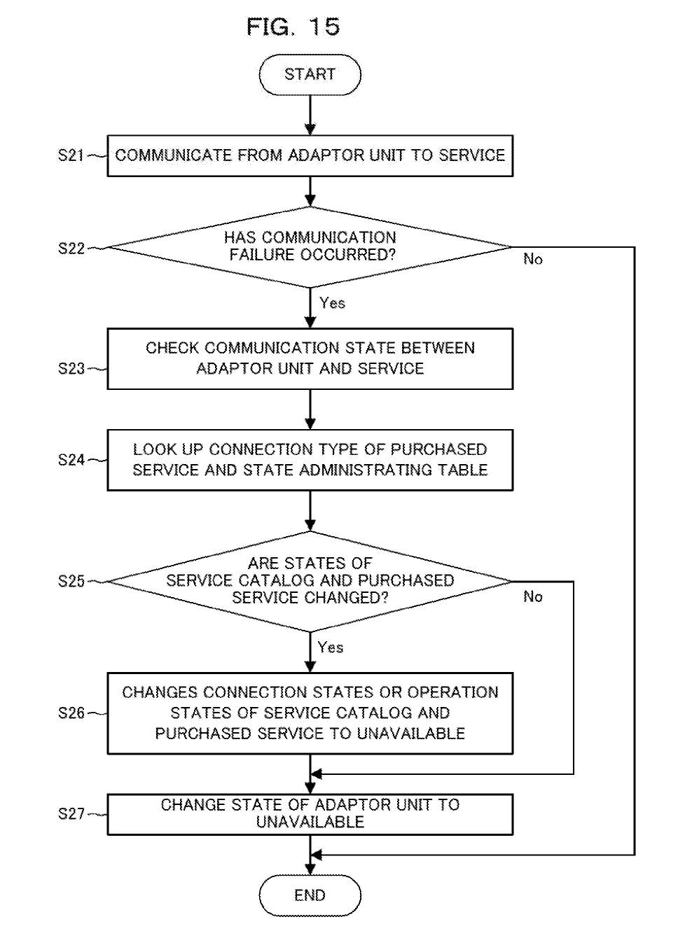

Referring to FIG. 14, state change processing (Steps S21-S27) in the service platform product in the information processing system 100 as configured described above as one example of an embodiment will be described, with reference to the flowchart depicted in FIG. 15.

FIG. 14 is a diagram illustrating an example of a state transition of the service platform product, in the information processing system 100 as one example of an embodiment.

The communication state check unit 115 carries out a communication from the adaptor unit 101 to the service 2 (Step S21 in FIG. 15).

The communication state check unit 115 determines whether a communication failure has occurred (i.e., “communication error”) (Step S22 in FIG. 15).

When no communication failure has been occurred (refer to the “No” route from Step S22 in FIG. 15), the processing ends.

Otherwise, when communication failure has occurred (refer to the reference symbol C1 in FIG. 14, and the “Yes” route from Step S22 in FIG. 15), the communication state check unit 115 checks the communication state between the adaptor unit 101 and the service 2 (Step S23 in FIG. 15). In other words, the communication state check unit 115 inquires the communication state of the service 2 or the service reality resource 24 (the reference symbol C2 in FIG. 14).

The table lookup unit 116 reads the connection type of the purchased service 103 and the state administration table 131 from the storage device 13, and looks them up (the reference symbol C3 in FIG. 14 and Step S24 in FIG. 15).

The decision unit 117 decides whether to change the states of the service catalog 102 and the purchased service 103 (Step S25 in FIG. 15).

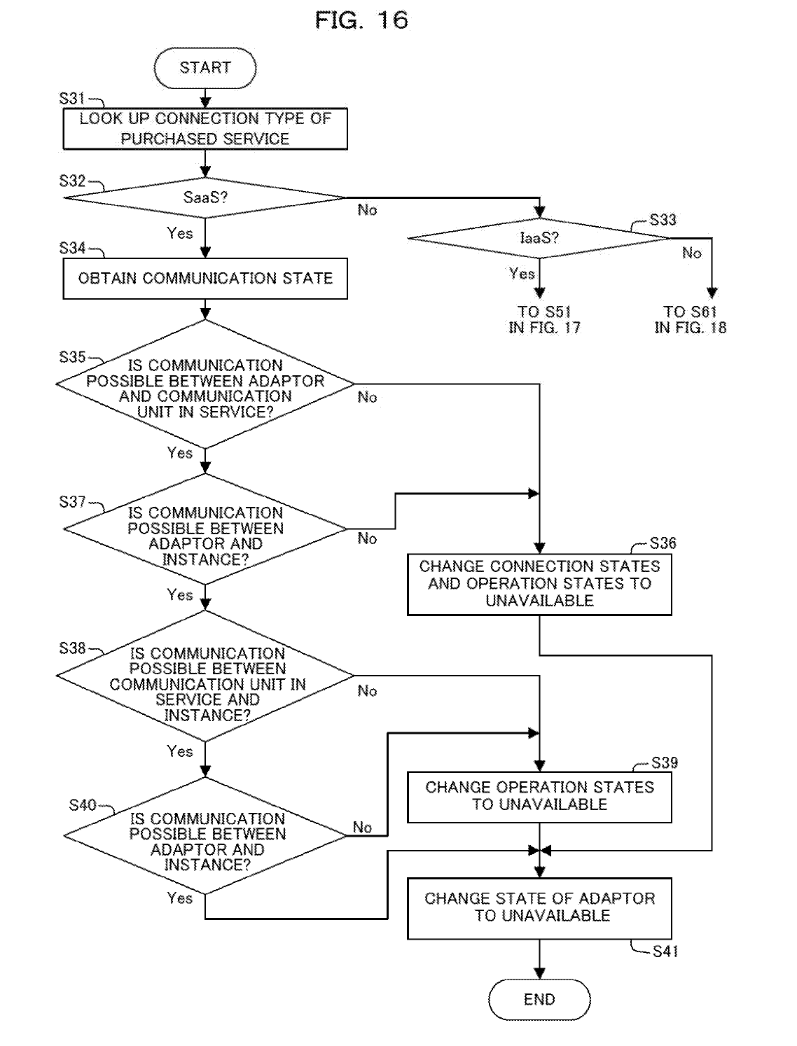

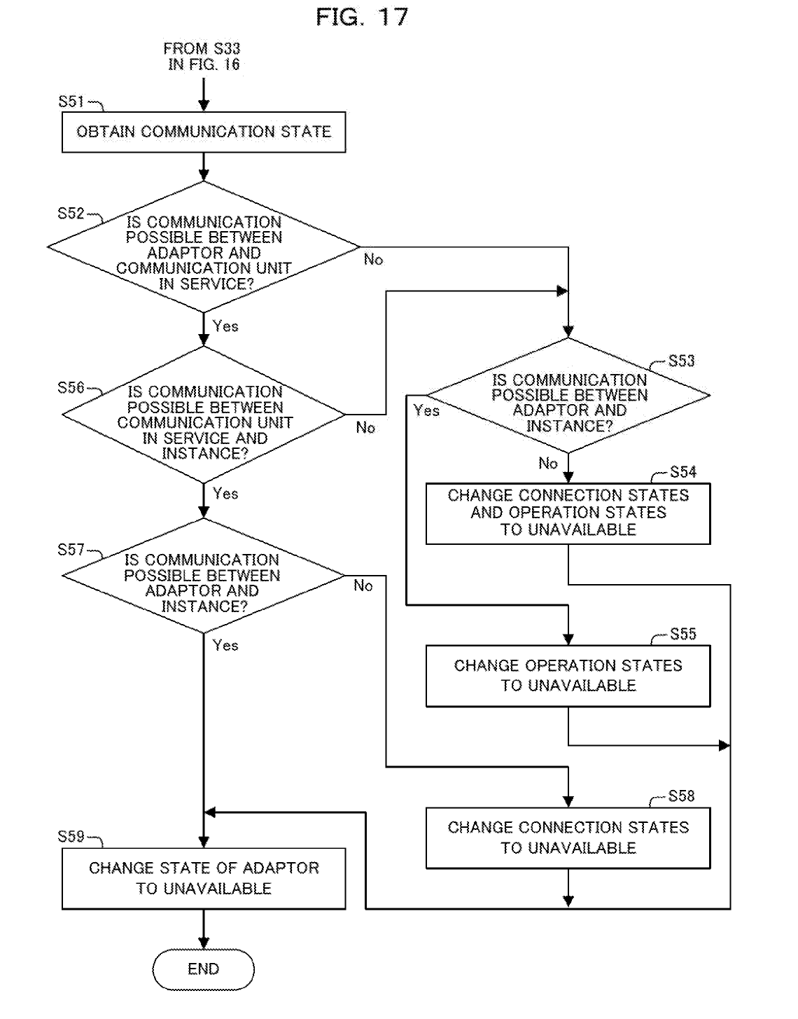

Details of the processing in Steps S24 and S25 in FIG. 15 will be described later with reference to FIGS. 16-17.

When the states of the service catalog 102 and the purchased service 103 are not to be changed (refer to the “No” route from Step S25 in FIG. 15), the processing transitions to Step S27.

Otherwise, when the states of the service catalog 102 and the purchased service 103 are to be changed (refer to the “Yes” route from Step S25 in FIG. 15), the decision unit 117 changes the states in accordance with the state administration table 131 (the reference symbol C4 in FIG. 14). In other words, the decision unit 117 changes the connection state or the operation state in the service catalog 102 and the purchased service 103 to unavailable (Step S26 in FIG. 15). Stated further differently, the decision unit 117 keeps the connection state or the operation state in the service catalog 102 and the purchased service 103 available, or changes them to unavailable (the reference symbol C5 and C6 in FIG. 14).

The decision unit 117 changes the state of the adaptor unit 101 to (i.e., “transitions to”) unavailable (the reference symbol C7 in FIG. 14 and Step S27 in FIG. 15).

Next, referring to flowcharts depicted in FIGS. 16-18, details of the state change processing (Steps S31-S41, S51-S59, and S61-S67) by the service platform product in the information processing system 100 as one example of an embodiment will be described.

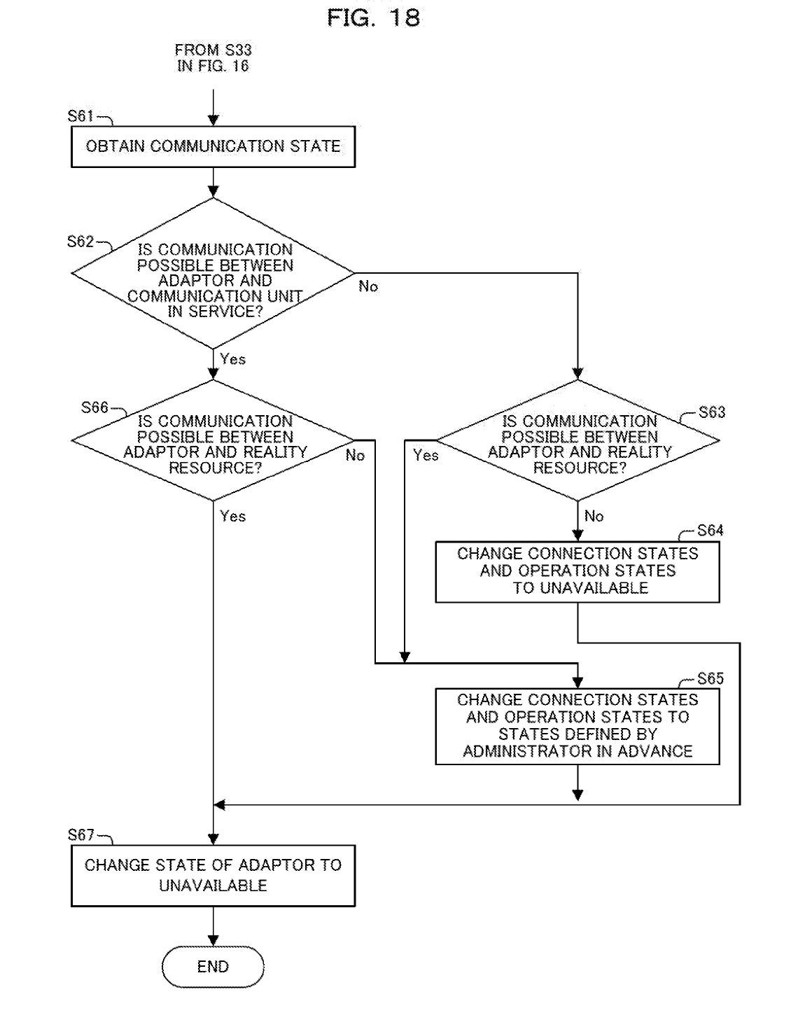

FIG. 16 depicts processing (Steps S31-S41) when the administrating server 1 is connected to the SaaS 21. FIG. 17 depicts processing (Steps S51-S59) when the administrating server 1 is connected to the IaaS 22. FIG. 18 depicts processing (Steps S61-S67) when the administrating server 1 is connected to the contract administrating cloud service 23.

The table lookup unit 116 looks up the connection type of the purchased service 103 (Step S31 in FIG. 16).

The communication state check unit 115 determines whether the connection type is the SaaS 21 (Step S32 in FIG. 16).

When the connection type is not the SaaS 21 (refer to the “No” route from Step S32 in FIG. 15), the communication state check unit 115 determines whether the connection type is the IaaS 22 (Step S33 in FIG. 16).

When the connection type is the IaaS 22 (refer to the “Yes” route from Step S33 in FIG. 16), the processing transitions to Step S51 in FIG. 17.

Otherwise, when the connection type is not the IaaS 22 (refer to the “No” route from Step S33 in FIG. 16), the processing transitions to Step S61 in FIG. 18.

When the connection type is the SaaS 21 in Step S32 in FIG. 16 (refer to the “Yes” route from Step S32 in FIG. 16), the communication state check unit 115 obtains the communication state between the administrating server 1 and the service 2 (Step S34 in FIG. 16).

The first communication determining unit 111 determines whether a communication is possible between the adaptor unit 101 and the communication unit 211 in the service 2 (Step S35 in FIG. 16).

When a communication is not possible between the adaptor unit 101 and the communication unit 211 in the service 2 (refer to the “No” route from Step S35 in FIG. 16), the decision unit 117 changes the connection state and the operation state in the service catalog 102 and the purchased service 103 to unavailable (Step S36 in FIG. 16). The processing then transitions to Step S41 in FIG. 16.

Otherwise, when a communication is possible between the adaptor unit 101 and the communication unit 211 in the service 2 (refer to the “Yes” route from Step S35 in FIG. 16), the third communication determining unit 113 determines whether a communication is possible between the adaptor unit 101 and the instances 212 (Step S37 in FIG. 16).

When a communication is not possible between the adaptor unit 101 and the instances 212 (refer to the “No” route from Step S37 in FIG. 16), the processing transitions to Step S36 in FIG. 16.

Otherwise, when a communication is possible between the adaptor unit 101 and the instances 212 (refer to the “Yes” route from Step S37 in FIG. 16), the second communication determining unit 112 determines whether a communication is possible between the communication unit 211 in the service 2 and the instances 212 (Step S38 in FIG. 16).

When a communication is not possible between the communication unit 211 in the service 2 and the instances 212 (refer to the “No” route from Step S38 in FIG. 16), the decision unit 117 changes the operation state in the service catalog 102 and the purchased service 103 to unavailable (Step S39 in FIG. 16). The processing then transitions to Step S41 in FIG. 16.

Otherwise, when a communication is possible between the communication unit 211 in the service 2 and the instances 212 (refer to the “Yes” route from. Step S38 in FIG. 16), the third communication determining unit 113 determines whether a communication is possible between the adaptor unit 101 and the instances 212 (Step S40 in FIG. 16).

When a communication is not possible between the adaptor unit 101 and the instances 212 (refer to the “No” route from Step S40 in FIG. 16), the processing transitions to Step S39 in FIG. 16.

Otherwise, when a communication is possible between the adaptor unit 101 and the instances 212 (refer to the “Yes” route from Step S40 in FIG. 16), the decision unit 117 changes the state of the adaptor unit 101 to incommunicable (Step S41 in FIG. 16). The processing then ends.

In FIG. 17, the communication state check unit 115 obtains the communication state between the administrating server 1 and the service 2 (Step S51 in FIG. 17).

The first communication determining unit 111 determines whether a communication is possible between the adaptor unit 101 and the communication unit 211 in the service 2 (Step S52 in FIG. 17).

When a communication is not possible between the adaptor unit 101 and the communication unit 211 in the service 2 (refer to the “No” route from Step S52 in FIG. 17), the third communication determining unit 113 determines whether a communication is possible between the adaptor unit 101 and the instances 212 (Step S53 in FIG. 17).

When a communication is not possible between the adaptor unit 101 and the instances 212 (refer to the “No” route from Step S53 in FIG. 17), the decision unit 117 changes the connection state and the operation state in the service catalog 102 and the purchased service 103 to unavailable (Step S54 in FIG. 17). The processing then transitions to Step S59 in FIG. 17.

Otherwise, when a communication is possible between the adaptor unit 101 and the instances 212 (refer to the “Yes” route from Step S53 in FIG. 17), the decision unit 117 changes the operation state in the service catalog 102 and the purchased service 103 to unavailable (Step S55 in FIG. 17). The processing then transitions to Step S59 in FIG. 17.

When a communication is possible between the adaptor unit 101 and the communication unit 211 in the service 2 in Step S52 in FIG. 17 (refer to the “Yes” route from Step S52 in FIG. 17), the second communication determining unit 112 determines whether a communication is possible between the communication unit 211 in the service 2 and the instances 212 (Step S56 in FIG. 17).

When a communication is not possible between the communication unit 211 in the service 2 and the instances 212 (refer to the “No” route from Step S56 in FIG. 17), the processing transitions to Step S53 in FIG. 17.

Otherwise, when a communication is possible between the communication unit 211 in the service 2 and the instances 212 (refer to the “Yes” route from Step S56 in FIG. 17), the third communication determining unit 113 determines whether a communication is possible between the adaptor unit 101 and the instances 212 (Step S57 in FIG. 17).

When a communication is not possible between the adaptor unit 101 and the instances 212 (refer to the “No” route from Step S57 in FIG. 17), the decision unit 117 changes the connection state in the service catalog 102 and the purchased service 103 to unavailable (Step S58 in FIG. 17). The processing then transitions to Step S59 in FIG. 17.

Otherwise, when a communication is possible between the adaptor unit 101 and the instances 212 (refer to the “Yes” route from Step S57 in FIG. 17), the decision unit 117 changes the state of the adaptor unit 101 to incommunicable (Step S59 in FIG. 17). The processing then ends.

In FIG. 18, the communication state check unit 115 obtains the communication state between the administrating server 1 and the service 2 (Step S61 in FIG. 18).

The first communication determining unit 111 determines whether a communication is possible between the adaptor unit 101 and the communication unit 211 in the service 2 (Step S62 in FIG. 18).

When a communication is not possible between the adaptor unit 101 and the communication unit 211 in the service 2 (refer to the “No” route from Step S62 in FIG. 18), the fourth communication determining unit 114 determines whether a communication is possible between the adaptor unit 101 and the service reality resource 24 (Step S63 in FIG. 18).

When a communication is not possible between the adaptor unit 101 and the service reality resource 24 (refer to the “No” route from Step S63 in FIG. 18), the decision unit 117 changes the connection state and the operation state in the service catalog 102 and the purchased service 103 to unavailable (Step S64 in FIG. 18). The processing then transitions to Step S67 in FIG. 18.

Otherwise, when a communication is possible between the adaptor unit 101 and the service reality resource 24 (refer to the “Yes” route from Step S63 in FIG. 18), the decision unit 117 changes the connection state and the operation state in the service catalog 102 and the purchased service 103, to a state defined by an administrator in advance (Step S65 in FIG. 18). The processing then transitions to Step S67 in FIG. 18.

When a communication is possible between the adaptor unit 101 and the communication unit 211 in the service 2 in Step S62 in FIG. 18 (refer to the “Yes” route from Step S62 in FIG. 18), the fourth communication determining unit 114 determines whether a communication is possible between the adaptor unit 101 and the service reality resource 24 (Step S66 in FIG. 18).

When a communication is not possible between the adaptor unit 101 and the service reality resource 24 (refer to the “No” route from Step S66 in FIG. 18), the processing transitions to Step S65 in FIG. 18.

Otherwise, when a communication is possible between the adaptor unit 101 and the service reality resource 24 (refer to the “Yes” route from Step S66 in FIG. 18), the decision unit 117 changes the state of the adaptor unit 101 to incommunicable (Step S67 in FIG. 18). The processing then ends.

(B) Miscellaneous

The disclosed technique is not limited to the aforementioned embodiment, and can be embodied in a wide variety of modifications without departing from the spirits of relevant the present embodiment. The configurations and processing in the present embodiment may be suitably selected or omitted, or may be combined where appropriate.

In accordance with the disclosed information processing apparatus, it is possible to precisely determine whether all or a part of a connected service is available.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus connected to a first computing machine configured to provide a service, the information processing apparatus comprises a processor configured to:
determine whether a communication is possible in a first segment, the first segment being defined between a communication unit that is provided in the first computing machine and communicates with the information processing apparatus, and a communication controller that is provided in the information processing apparatus and communicates with the service;
determine whether a communication is possible in a second segment, the second segment being defined between the communication controller and one of a virtual machine provisioned in the first computing machine, an address of the service, and a second computing machine different from the first computing machine; and
decide whether the service is available, a part of the service is available, or the service is unavailable, in accordance with a combination of a determination result for the first segment and a determination result for the second segment.

2. The information processing apparatus according to claim 1, wherein the processor is further configured to:
determine whether a communication is possible in a third segment, the third segment being defined between the communication unit, and the virtual machine or the address,
decide whether the service is available, the part of the service is available, or the service is unavailable, in accordance with a combination of the determination result for the first segment, the determination result for the second segment, and a determination result for the third segment.

3. The information processing apparatus according to claim 1, wherein
the first computing machine is configured to provide the service before a contract with a user, and
the second computing machine is configured to provide the user with the service after the contract with the user.

4. An information processing system comprising:
an information processing apparatus; and
a first computing machine configured to provide a service,
wherein the information processing apparatus comprises a processor configured to:
determine whether a communication is possible in a first segment, the first segment being defined between a communication unit that is provided in the first computing machine and communicates with the information processing apparatus, and a communication controller that is provided in the information processing apparatus and communicates with the service;
determine whether a communication is possible in a second segment, the second segment being defined between the communication controller and one of a virtual machine provisioned in the first computing machine, an address of the service, and a second computing machine different from the first computing machine; and
decide whether the service is available, a part of the service is available, or the service is unavailable, in accordance with a combination of a determination result for the first segment and a determination result for the second segment.

5. The information processing system according to claim 4, wherein the processor is further configured to:
determine whether a communication is possible in a third segment, the third segment being defined between the communication unit, and the virtual machine or the address,
decide whether the service is available, the part of the service is available, or the service is unavailable, in accordance with a combination of the determination result for the first segment, the determination result for the second segment, and a determination result for the third segment.

6. The information processing system according to claim 4, wherein
the first computing machine is configured to provide the service before a contract with a user, and
the second computing machine is configured to provide the user with the service after the contract with the user.

7. A non-transitory computer-readable recording medium having a program stored therein, the program causing a computer provided in an information processing apparatus connected to a first computing machine configured to provide a service to execute processing to:
determine whether a communication is possible in a first segment, the first segment being defined between a communication unit that is provided in the first computing machine and communicates with the information processing apparatus, and a communication controller that is provided in the information processing apparatus and communicates with the service;
determine whether a communication is possible in a second segment, the second segment being defined between the communication controller and one of a virtual machine provisioned in the first computing machine, an address of the service, and a second computing machine different from the first computing machine; and
decide whether the service is available, a part of the service is available, or the service is unavailable, in accordance with a combination of a determination result for the first segment and a determination result for the second segment.

8. The non-transitory computer-readable recording medium according to claim 7, wherein the program causes the computer to execute processing to:
determine whether a communication is possible in a third segment, the third segment being defined between the communication unit, and the virtual machine or the address,
decide whether the service is available, the part of the service is available, or the service is unavailable, in accordance with a combination of the determination result for the first segment, the determination result for the second segment, and a determination result for the third segment.

9. The non-transitory computer-readable recording medium according to claim 7, wherein
the first computing machine is configured to provide the service before a contract with a user, and
the second computing machine is configured to provide the user with the service after the contract with the user.

10. A method of processing information, in an information processing system comprising an information processing apparatus and a first computing machine configured to provide a service, the method comprising, by the information processing apparatus:
determining whether a communication is possible in a first segment, the first segment being defined between a communication unit that is provided in the first computing machine and communicates with the information processing apparatus, and a communication controller that is provided in the information processing apparatus and communicates with the service;
determining whether a communication is possible in a second segment, the second segment being defined between the communication controller and one of a virtual machine provisioned in the first computing machine, an address of the service, and a second computing machine different from the first computing machine; and
deciding whether the service is available, apart of the service is available, or the service is unavailable, in accordance with a combination of a determination result for the first segment and a determination result for the second segment.

11. The method of processing information according to claim 10, further comprising, by the information processing apparatus:
determining whether a communication is possible in a third segment, the third segment being defined between the communication unit, and the virtual machine or the address,
deciding whether the service is available, the part of the service is available, or the service is unavailable, in accordance with a combination of the determination result for the first segment, the determination result for the second segment, and a determination result for the third segment.

12. The method of processing information according to claim 10, wherein
the first computing machine is configured to provide the service before a contract with a user, and
the second computing machine is configured to provide the user with the service after the contract with the user.
